(19) United States
(12) Patent Application Publication
(10) Pub. No.: US 2021/0094257 A1
(43) Pub. Date: Apr. 1, 2021

(54) FABRIC FOR FUSION BONDING AND MULTILAYER BODY COMPRISING SAID FABRIC FOR FUSION BONDING

(71) Applicant: KURARAY CO., LTD., Kurashiki-shi, Okayama (JP)

(72) Inventors: Shoji Onogi, Kurashiki-shi, Okayama (JP); Hitoshi Nakatsuka, Kurashiki-shi, Okayama (JP); Takayuki Ikeda, Kurashiki-shi, Okayama (JP); Shinya Kawakado, Saijo-shi, Ehime (JP)

(73) Assignee: KURARAY CO., LTD., Kurashiki-shi, Okayama (JP)

(21) Appl. No.: 15/733,401

(22) PCT Filed: Feb. 19, 2019
(86) PCT No.: PCT/JP2019/006151

§ 371 Date: Jul. 21, 2020

(30) Foreign Application Priority Data
Feb. 26, 2018 (JP) 2018-032030

(51) Int. Cl. B32B 5/26; B32B 5/02; D04H 1/549

(52) U.S. Cl. CPC B32B 5/26; B32B 5/022; D04H 1/541; D04H 1/549; B32B 5/026

(57) ABSTRACT

A fusing fabric may be used for thermal fusion of a plurality of plies of fabric. The fusing fabric contains at least partially fusible fibers containing a resin that has a melting point of 150° C. or lower or a softening point of 110° C. or lower, and has an air permeability of 1000 cm³/cm²·s or more to 10000 cm³/cm²·s or less.

This application is the National Stage entry under § 371 of International Application No. PCT/JP2019/006151, filed on Feb. 19, 2019, and which claims the benefit of Japanese Application No. 2018-032030, filed on Feb. 26, 2018. The entireties of both of these applications are hereby incorporated by reference.

### TECHNICAL FIELD

The present invention relates to a fusing fabric which is particularly applicable to clothing and body supporting members requiring thermal fusion of plies of fabric, such as underwear, outerwear, and brassieres, and to a laminate including the fusing fabric, and having an anti-fray effect, high breathability, and air permeability maintained before and after a thermal fusion process.

### BACKGROUND ART

In the fields of clothing and body supporting members, in particular, brassieres and corsets, a plurality of plies of fabric are stacked, and then molded into one piece through thermal fusion for the purposes of reducing fraying, and supporting or shaping the body. In general, to reduce the fraying, a fusing material is required to have a high fusion property, and therefore, the fusing material must be heated to a temperature near its melting point to perform thermal fusion. However, the existing fusing materials cannot achieve the thermal fusion at low temperatures, and there are concerns about texture and air permeability of the resulting products.

Therefore, in recent years, a plurality of plies of fabric can be molded into a product through fusion with a thermoplastic film which can be thermally fusible at low temperatures sandwiched therebetween, so that the resulting product can maintain its texture even after the thermal fusion (see Patent Document 1). Further, in order to provide a fusion film with improved air permeability, the fusion film has been made porous to improve breathability of the product (see Patent Document 2).

Despite the development of such a fusion film with improved air permeability, there are still great concerns about the air permeability. This is because the clothing and the body supporting members are often worn in close contact with the body, which makes the concern about the air permeability more sensitive. Specifically, as for products that require thermoforming, there is a limit on the improvement in air permeability by the fusion film.

There is also a method using no film. In this method, fusible fibers are incorporated as one of components of fabric, and the thermally fusible fibers are fused at their surfaces in contact with each other, so that the fraying can be reduced (see Patent document 3). According to this method, clothing that can accomplish the purposes can be obtained without greatly changing not only the texture of the fabric, but also characteristics of the fused fabric, such as a basis weight.

However, in the above method, how the fusible fibers are incorporated into the fabric forming the product needs to be designed, which lowers the degree of freedom in use, and is not suitable for developing various kinds of products.

### CITATION LIST

### Patent Documents

Patent Document 1: Japanese Unexamined Patent Publication No. 2006-181782
Patent Document 2: Japanese Unexamined Patent Publication No. 2008-188202
Patent Document 3: Japanese Unexamined Patent Publication No, 2009-209480

### SUMMARY OF THE INVENTION

### Technical Problem

In view of the foregoing, an object of the present invention is to easily provide clothing and body supporting members that exhibit an anti-fray effect, high breathability, and good texture even after a thermal fusion process only by means of incorporating fabric made of fibers which is thermally fusible at low temperatures between plies of fabric to be thermally fused together in the fields of clothing and body supporting members which require thermal fusion of plies of fabric, such as underwear, outerwear, and brassieres.

### Solution to the Problem

As a result of studies to solve the problems described above, the inventors of the present invention have found that clothing and a body supporting member having an anti-fray effect and high breathability even after a thermal fusion process can be easily obtained through mere incorporation of a fusing fabric used for thermal fusion of a plurality of plies of fabric between the plies, the fusing fabric containing at least partially fusible fibers made of a resin having a melting point of 150° C. or lower or a softening point of 110° C. or lower, and having an air permeability of 1000 cm³/cm²·s or more and 10000 cm³/cm²·s or less.

The fusing fabric may have a basis weight of 15 g/m² or more to 80 g/m² or less.

The fusible fibers may be modified ethylene vinyl alcohol copolymer fibers or modified polyamide fibers.

The present invention may also provide a laminate at least partially containing the fusing fabric, and a plurality of plies of fabric to be thermally fused.

The laminate may have a peel strength of 10 N/cm or more, and an air permeability of 5 cm³/cm²·s or more.

The laminate at least partially containing the fusing fabric and a plurality of plies of fabric to be thermally fused may be produced by a method of heating the fusing fabric and the plies of fabric at a temperature of 150° C. or lower to be fused.

### Advantages of the Invention

In the present invention, a thermally fusing material is in the shape of fabric. Thus, even after a dry heat treatment or a hydrothermal treatment such as dyeing, the resulting product can be provided with high air permeability without greatly changing not only the texture of the fabric, but also characteristics of the fused fabric, such as a basis weight. Moreover, there is no need to design how to incorporate the fusible fibers into each ply of fabric forming the product. This can provide a high degree of freedom in use, and the product can be easily obtained.

### DETAILED DESCRIPTION

An embodiment of the present invention will now be described in detail below. In the present invention, fabric means a fibrous structure including a woven fabric, a knitted fabric, a braid, a nonwoven fabric, a leather, and the like. It is important that fusible fibers forming the fusing fabric according to the present invention are fusible fibers made of a resin having a melting point of 150° C. or lower or a softening point of 110° C. or lower. Examples of the fusible fibers which are made of a resin having a melting point of 150° C. or lower or a softening point of 110° C. or lower and can be fused at low temperatures include modified polyester fibers, modified polyamide fibers, polyurethane fibers, polyolefin fibers, and modified ethylene vinyl alcohol copolymer (will be hereinafter referred to as “modified EV011”) fibers. The melting point of the resin used for the fusible fibers is preferably 130° C. or lower, more preferably 110° C. or lower. The lower limit of the melting point of the resin used for the fusible fibers is not particularly limited, but is preferably 40° C. or higher from the viewpoint of storage stability. The present invention is also applicable to fusible fibers using a resin whose melting point is generally not determined, and in this case, it is important that the resin used for the fusible fibers has a softening point of 110° C. or lower. The lower limit of the softening point of the resin used for the fusible fibers is not particularly limited, but is preferably 30° C. or higher from the viewpoint of storage stability. Among the above-listed fusible fibers, the modified polyimide fibers and the modified EVOH fibers, which are good in adhesion to a nylon fabric, are particularly preferred because nylon is often used for the underwear and the body supporting members.

The fusible fibers forming the fusing fabric according to the present invention may be composite fibers made of a plurality of resin components, as long as they do not impair the advantages of the present invention. Specifically, the composite fibers may be made of a resin having a fusion property (will be hereinafter referred to as a “fusible resin”) as one component, and a resin or resins other than the fusible resin as additional component(s). The composite fibers may have any cross-sectional shape as long as the fusible resin is exposed only In particular, composite fibers having a sea-island or core-sheath cross section thich the fusible resin is exposed over the entire surface layer are suitable.

In the composite fibers, if a functional resin is used as a component other than the fusible resin, functionality can be given to a product by fusion. If a polyurethane resin, for example, is used as the functional resin, a product with good stretchability can be obtained. Further, if a resin containing inorganic particles is used, a product exhibiting characteristics of the inorganic particles can be obtained. For example, if antibacterial particles such as zinc oxide or copper particles are added, a laminate obtained after the fusion can be provided with antibacterial properties.

The fusing fabric according to the present invention may contain other fibers besides the fusible fibers, as long as the advantages of the present invention are not impaired. For example, the fusing fabric may be a woven fabric using commonly used thermoplastic fibers as warp yarns and the fusible fibers as weft yarns.

It is important for the fusing fabric according to the present invention to have an air permeability of 1000 cm³/cm²·s or more to 10000 cm³/cm²·s or less. More preferably, the air permeability is 1500 cm³/cm²·s or more to 8000 cm³/cm²·s or less. The inventors of the present invention have found that if the fusing fabric has the air permeability in the above range, a laminate having sufficient breathability and peel strength even after molding is obtained. If the air permeability of the fusing fabric is less than 1000 cm³/cm²·s, the molded laminate cannot be provided with sufficient breathability, and if the air permeability exceeds 10000 cm³/cm²·s, the molded laminate cannot be provided with sufficient peel strength.

The fusing fabric according to the present invention preferably has a basis weight of 15 g/m² or more to 80 g/m² or less. The basis weight is more preferably 20 g/m² or more to 70 g/m² or less. If the basis weight of the fusing fabric is less than the lower limit, the molded laminate may be insufficient in peel strength, and if the basis weight exceeds the upper limit, the molded laminate may be insufficient in breathability.

Although not limited, the fusible fibers used for the fusing fabric according to the present invention preferably have a single yarn fineness of 0.2 dtex or more to 20 dtex or less. The single yarn fineness is more preferably 2.0 dtex or more to 12 dtex or less. If the single yarn fineness exceeds 20 dtex, the fusible fibers do not spread smoothly to fabric to be fused when molten at 110° C., which is a typical steam set temperature, and the molded lamina may be insufficient breathability. If the single yarn fineness is less than 0.2 dtex, the molded laminate may be insufficient in peel strength because the contact area per single yarn is small, and the yarns may be tom by tension applied during a process using a knitting machine, a loom, or the like.

In addition, the fusing fabric according to the present invention preferably has a thickness of 0.1 mm or more to 1.5 mm or less. If the thickness is less than the lower limit, the molded laminate may be insufficient in peel strength, and the total amount of fusion yarns to be used may decrease, causing fusion spots to be formed easily in the laminate. If the thickness exceeds the upper limit, the fusible fibers are fused together and fill the meshes when heated, which may make the breathability of the molded laminate insufficient. The thickness of the fusing fabric is more preferably 0.3 mm or more to 1.0 mm or less.

A laminate which is suitably used for clothing and body supporting members having an anti-fray effect and high breathability even after a thermal fusion process can be easily obtained if the laminate partially contains the fusing fabric, and a plurality of plies of fabric to be fused. Here, the thermal fusion may be performed in any way without particular limitations, and may be direct heating such as pressing, or indirect heating using a heater. The thermal fusion may also be heating under wet conditions, such as in hot water. Heating is preferably carried out at a temperature not higher than a temperature at which the texture of the fabric is not impaired.

Alternatively, the laminate is easily obtained through heating the fusing fabric and the plies of fabric at a temperature of 150° C. or lower to be fused. The temperature is more preferably 130° C. or lower, and still more preferably 110° C. or lower, which is a steam set temperature in a typical fabric processing site. When a dry heat treatment is performed at a temperature higher than 150° C., fabric such as nylon, which is sensitive to heat, may be deteriorated in texture.

The laminate obtained through fusion using the fusing fabric preferably has an air permeability of 5 cm³/cm²·s or more and a peel strength of 10 N/cm or more. More preferably, the air permeability is 10 cm³/cm²·s or more, and the peel strength is 20 N/cm or more. In designing of the laminate, the following two conditions need to be satisfied. Specifically, the laminate needs to provide ensured breathability and comfortability so as not to cause a user to feel stuffy, and to have a peel resistance so that the laminate is not peeled off even after repeated washing. The inventors of the present invention have found that sufficient comfortability and peel resistance are obtained if the air permeability and peel strength of the laminate are within the ranges described above. If the air permeability is less than the above-described value, the laminate may be evaluated to cause a stuffy feeling in a sensory evaluation, and if the peel strength is less than the above-described value, the laminate may partially be peeled off after washing.

### EXAMPLES

The present invention will be described in more detail by way of examples, but the present invention is not limited to the examples.

### Example 1

(Production of 6 Mol % Modified EVOH Fibers)

As a modified EVOH component, a 6 mol % modified EVOH (trade name: EX 861, manufactured by Kuraray Co., Ltd.) containing 44 m thermoplastic ethylene and having a degree of saponification of 99.9% was molten at 230° C. using an extruder, then guided to a spin pack, and discharged from a nozzle with 12 holes each having a diameter of 0.25 mm at a spinneret temperature of 230° C. Thus, fibers were discharged from the spinning nozzle. Threads discharged from the spinneret were cooled using a 1.0 m-long cooling device which blows the air in a transverse direction. Thereafter, a spinning oil made of an antistatic component containing no water and a smoothing component was applied to the threads. Then, the threads were taken up via a roller at a take-over speed of 2000 m/min to obtain 6 mol % modified EVOH fibers of 78 dtex/12f of the present example.

(Production of Ny-6 Fibers)

As nylon-6 hereinafter referred to as “Ny-6”), Ny-6 (1015B) manufactured by Ube Industries Co., Ltd. was molten at 270° C. using an extruder, then guided to a spin pack, and discharged from a nozzle with 24 holes each having a diameter of 0.25 mm at a spinneret temperature of 270° C. Thus, fibers were discharged from the spinning nozzle. Threads discharged from the spinneret were cooled using a 1.0 m-long cooling device which blows the air in a transverse direction. Thereafter, a water emulsion oil made of an antistatic component and a smoothing component was applied as a spinning oil to the threads. Then, the threads were taken up via a roller at a take-over speed of 4000 m/min to obtain Ny-6 fibers of 78 dtex/12f of the present example.

(Production of Laminate of 6 mol % Modified EVOH Weft Knitted Fabric and Ny-6 Warp Knitted Fabric)

Using the Ny-6 fibers and a warp knitting machine, a Ny-6 warp knitted fabric having a basis weight of 180 g/m², a single yarn fineness of 6.5 dtex, a thickness of 1,301 mm, and an air permeability of 105 cm³/cm²·s was produced. This was used as a fabric to be fused with a fusing fabric. Using the 6 mol % modified. EVOH fibers and a tube knitting machine, a 6 mol % modified EVOH weft knitted fabric having a basis weight of 19 g/m², a single yarn fineness of 6.5 dtex, a thickness of 0.291 mm, and an air permeability of 8283 cm³/cm²·s was prepared. This was used as the fusing fabric (fusion material). Then, a piece of the 6 mol % modified EVOH weft knitted fabric serving as the fusion material was sandwiched between two plies of the Ny-6 warp knitted fabric, which was then heated and pressurized with a steam iron at 110° C. for 30 seconds to produce a laminate of the 6 mol % modified EVOH weft knitted fabric and the Ny-6 warp knitted fabric.

(Measurement of Melting Point)

In accordance with HS K 7121, measurement was performed using a differential scanning calorimeter (DSC-60) manufactured by Shimadzu Corporation at a temperature increase rate of 10° C./min. Indium and lead were used for the calibration of the temperature. A melting peak temperature (Tpm) in accordance with the JIS standard was obtained from a chart of the second run, which was regarded as the melting point.

(Measurement of Softening Point)

Measurement and calculation were performed using a differential the a TAS200 manufactured by Rigaku Co., Ltd. in a nitrogen atmosphere at a temperature increase rate of 10° C./min.

(Measurement of Basis Weight)

The hasis weight (g/m²) of each of the produced weft knitted fabric, warp knitted fabric, nonwoven fabric, and laminate was measured in accordance with HS L 1096.

(Measurement of Air Permeability)

An air-flow resistance value R (kPa's/m) of each of the produced weft knitted fabric, warp knitted fabric, nonwoven fabric, and laminate was measured using a KES-F8-AP1 air permeability tester manufactured by Katotec Co., Ltd., and a value V (cm³/cm²·s) was calculated from the following mathematical equation (1), which was regarded as the air permeability.

[Math. 1]

V=124.55/(R×10) (1)

(Air Permeability Retention Rate)

Using values of the air permeability of the laminate measured before and after the fusion, a value P was calculated from the following mathematical equation (2), which was regarded as the air permeability retention rate.

[Math. 2]

P=(air permeability of laminate after fusion(cm³/cm²·s)/air permeability(cm³/cm²·s) of laminate before fusion)×100 (2)

(Evaluation of Breathability)

The breathability of the produced laminate was evaluated through a sensory evaluation. A fused sample of 100 mm length×100 mm width was produced, and then evaluated by three test users in terms of stuffiness and discomfort. Thereafter, the breathability of the laminate was evaluated as described below.

Good: Good breathability (all three test users perceived no stuffiness and discomfort) Average: Acceptable breathability (one of three test users perceived stuffiness and discomfort)

Poor: Poor breathability (two of three test users perceived stuffiness and discomfort)

(Measurement of Peel Strength)

To measure the peel strength of the produced laminate, a sample of the laminate, 50 mm length×10 mm width, was subjected to a 180 degree T-peel test using a universal tester Tensilon RIG-1250 manufactured by A&D Company Limited, with a chuck interval set to 20 mm and a tensile speed to 40 mm/min.

(Evaluation of Fusion Property)

A fusion property of the produced laminate was evaluated based on peel resistance after washing. After washing 50 times, samples were evaluated according to the following criteria. The washing was carried out according to Method 103 of KS L 0217 for household electric washing machines.

Good: Good fusion property (no peeling at the fused portion)

Average: Acceptable fusion property (an edge of the fused portion peeled, and a peeling area was less than 10% of the fused portion)

Poor: Poor fusion property fused portion further peeled from its edge, and a peeling area was equal to or more than 10% of the fused portion)

(Evaluation of Texture)

The texture of the produced laminate was evaluated in the following manner in a sensory evaluation.

Excellent: The fabric had no change in hardness before and after a heat treatment

Good: The fabric was hardened in part of its surface, but had little change in hardness as a whole.

Poor: The fabric became harder and stronger than before the heat treatment Table 1 shows the results.

### Example 2

A weft knitted fabric (basis weight: 25 g/m², single yarn fineness: 6.5 dtex, thickness: 0.389 mm, air permeability: 5514 cm³/cm²·s) having a greater basis weight than the 6 mol % modified EVOH weft knitted fabric of Example 1 was produced, which was used as a fusing fabric (a fusion material). In the same manner as in Example 1, a laminate of 6 mol % modified EVOH weft knitted fabric and Ny-6 warp knitted fabric was produced, and its air permeability, air permeability retention rate, peel strength, breathability, fusion property, and texture were evaluated. Table 1 shows the results.

### Example 3

A weft knitted fabric (basis weight: 41 g/m², single yarn fineness: 6.5 dtex, thickness: 0.736 mm, air permeability: 2060 cm³/cm²·s) having a greater basis weight than the 6 mol % modified EVOH weft knitted fabric of Example 2 was produced, which was used as a fusing fabric (fusion material). In the same manner as in Example 1, a laminate of 6 mol % modified EVOH weft knitted fabric and Ny-6 warp knitted fabric was produced, and its air permeability, air permeability retention rate, peel strength, breathability, fusion property, and texture were evaluated. Table 1 shows the results.

### Example 4

A weft knitted fabric (basis weight: 75 g/m², single yarn fineness: 6.5 dtex, thickness: 1.195 mm, air permeability: 1205 cm³/cm²·s) having a greater basis weight than the 6 mol % modified. EVOH weft knitted fabric of Example 3 was produced, which was used as a fusing fabric (fusion material). In the same manner as in Example 1, a laminate of 6 mol % modified EVOH weft knitted fabric and Ny-6 warp knitted fabric was produced, and its air permeability, air permeability retention rate, peel strength, breathability, fusion property, and texture were evaluated. Table 1 shows the results.

### Example 5

(Production of Modified Ny Weft Knitted Fabric)

Using FLOR-M (110T12f) manufactured by Unitika Co., Ltd., which is modified nylon (hereinafter referred to as “modified Ny”) fibers as modified polyamide fibers, and a tube knitting machine, a weft knitted fabric (basis weight: 17 g/m², single yarn fineness: 9.2 dtex, thickness: 0.288 mm, air permeability: 9569 cm³/cm²·s) was produced, which was used as a fusing fabric (fusion material). In the same manner as in Example 1, a laminate of modified Ny weft knitted fabric and Ny-6 warp knitted fabric was produced, which was then heated and pressurized with a steam iron at 110° C. for 30 seconds, and its air permeability, air permeability retention rate, peel strength, breathability, fusion property, and texture were evaluated. Table 1 shows the results.

### Example 6

A weft knitted fabric (basis weight: 22 g/m², single yarn fineness: 9.2 dtex, thickness: 0.466 mm, air permeability: 6667 cm³/cm²·s) having a greater basis weight than the modified Ny weft knitted fabric of Example 5 was produced, which was used as a fusing fabric (fission material). In the same manner as in Example 5, a laminate of modified Ny weft knitted fabric and Ny-6 warp knitted fabric was produced, and its air permeability, air permeability retention rate, peel strength, breathability, fusion property, and texture were evaluated. Table 1 shows the results.

### Example 7

A weft knitted fabric (basis weight: 40 g/m², single yarn fineness: 9.2 dtex, thickness: 0.742 mm, air permeability: 2490 cm³/cm²·s) having a greater basis weight than the modified Ny weft knitted fabric of Example 6 was produced, which was used as a fusing fabric (fusion material). In the same manner as in Example 5, a laminate of modified Ny weft knitted fabric and Ny-6 warp knitted fabric was produced, and its air permeability, air permeability retention rate, peel strength, breathability, fusion property, and texture were evaluated. Table 1 shows the results.

### Example 8

A weft knitted fabric (basis weight: 72 g/m², single yarn fineness: 9.2 dtex, thickness: 1.004 mm, air permeability: 1313 cm³/cm²'s) having a greater basis weight than the modified Ny weft knitted fabric of Example 7 was produced, which was used as a fusing fabric (fusion material). In the same manner as in Example 5, a laminate of modified. Ny weft knitted fabric and Ny-6 warp knitted fabric was produced, and its air permeability, air permeability retention rate, peel strength, breathability, fusion property, and texture were evaluated. Table 1 shows 1 results.

### Example 9

The 6 mol % modified EVOH fibers of Example were cut short (fiber length: 76 mm), and entangled by needle punching to produce a nonwoven fabric (basis weight: 52 g/m², single yarn fineness: 6.5 dtex, thickness: 0.501 mm, air permeability: 2911 cm³/cm²·s), which was used as a fusing fabric (fusion material), Then, in the same manner as in Example 1, a laminate of 6 mol % modified EVOH nonwoven fabric and Ny-6 warp knitted fabric was produced, and its air permeability, air permeability retention rate, peel strength, breathability, fusion property, and texture were evaluated. Table 1 shows the results.

### Example 10

The modified Ny fibers of Example 5 were cut short (fiber length: 76 mm), and entangled by needle punching to produce a nonwoven fabric (basis weight: 46 g/m², single yarn fineness: 9.2 dtex, thickness: 0.399 mm, air permeability: 3176 cm³/cm²·s), which was used as a fusing fabric (fusion material). Then, in the same manner as in Example 5, a laminate of modified Ny nonwoven fabric and Ny-6 warp knitted fabric was produced, and its air permeability, air permeability retention rate, peel strength, breathability, fusion property, and texture were evaluated. Table 1 shows the results.

### Example 11

(Production of 4 mol % Modified EVOH Fibers)

Chips of 6 mol % modified EVOH (EX 861, manufactured by Kuraray Co., Ltd.) containing 44 mol % thermoplastic ethylene and having a degree of saponification of 99.9% were blended with chips of unmodified EVOH (E-112YS, manufactured by Kuraray Co., Ltd.) in a weight ratio of 2:1. Then, the obtained blend was molten at 230° C. using an extruder, thereafter guided to a spin pack, and discharged from a nozzle with 12 holes each having a diameter of 0.25 mm at a spinneret temperature of 230° C. Thus, fibers were discharged from the spinning nozzle. Threads discharged from the spinneret were cooled using a 1.0 m-long cooling device which blows the air in a transverse direction. Thereafter, a spinning oil made of an antistatic component containing no water and a smoothing component was applied to the threads. Then, the threads were taken up via a roller at a take-over speed of 2000 m/min to obtain 4 mol % modified EVOH fibers of 78 dtex/12f of the present example. In the same manner as in Example 1, a 4 mol % modified EVOH weft knitted fabric and a Ny-6 warp knitted fabric were stacked, which was then heated and pressurized with a steam iron at 150° C. for 30 seconds to produce a laminate, and its air permeability, air permeability retention rate, peel strength, breathability, fusion property, and texture were evaluated. Table 1 shows the results.

### Example 12

(Production of Polyurethane Fibers)

A thermoplastic polyurethane elastomer (hereinafter referred to as “TPU”) (E580, manufactured by Nippon Miractran Co, Ltd.) was molten at 230° C. using an extruder, then guided to a spin pack, and discharged from a nozzle with 12 holes each having a diameter of 0.5 mm at a spinneret temperature of 230° C. Thus, fibers were discharged from the spinning nozzle. Threads discharged from the spinneret were cooled using a 1.0 m-long cooling device which blows the air in a transverse direction. Thereafter, a silicone-based oil was applied as a spinning oil to the threads. Then, the threads were taken up via a roller at a take-over speed of 100 m/min to obtain TPU fibers of 78 dtex/12f of the present example. In the same manner as in Example 1, a TPU weft knitted fabric and a Ny-6 warp knitted fabric were stacked, which was then heated and pressurized with a steam iron at 150° C. for 30 seconds to produce a laminate, and its air permeability, air permeability retention rate, peel strength, breathability, fusion property, and texture were evaluated. Table 1 shows the results.

### Comparative Example 1

A weft knitted fabric (basis weight: 11 g/m², single yarn fineness: 6.5 dtex, thickness: 0.191 mm, air permeability: 16492 cm³/cm²·s) having a smaller basis weight than the 6 mol % modified EVOH weft knitted fabric of Example 1 was produced, which was used as a fusing fabric (fusion material). In the same manner as in Example 1, a laminate of 6 mol % modified EVOH weft knitted fabric and Ny-6 warp knitted fabric was produced, and its air permeability, air permeability retention rate, peel strength, breathability, fusion property, and texture were evaluated. Table 1 shows the results.

### Comparative Example 2

A weft knitted fabric (basis weight: 106 g/m², single yarn fineness: 6.5 dtex, thickness: 1.508 mm, air permeability: 405 cm³/cm²·s) having a greater basis weight than the 6 mol % modified EVOH weft knitted fabric of Example 4 was produced, which was used as a fusing fabric (fusion material). In the same manner as in Example 1, a laminate of 6 mol % modified EVOH well knitted fabric and Ny-6 warp knitted fabric was produced, and its air permeability, air permeability retention rate, peel strength, breathability, fusion property, and texture were evaluated. Table 1 shows the results.

### Comparative Example 3

(Production of Unmodified EVOH Fibers)

As an EVOH resin, EVOH manufactured by Kuraray Co., Ltd. (E-112YS) was molten at 230° C. using an extruder, then guided to a spin pack, and discharged from a nozzle with 24 holes each having a diameter of 0.25 mm at a spinneret temperature of 230° C. Thus, fibers were discharged from the spinning nozzle. Threads discharged from the spinneret were cooled using a 1.0 m-long cooling device which blows the air in a transverse direction. Thereafter, a water emulsion oil made of an antistatic component and a smoothing component was applied as a spinning oil to the threads. Then, the threads were taken up via a roller at a take-over speed of 4000 m/min to obtain unmodified EVOH fibers of 78 dtex/12f of the present comparative example.

(Production of Laminate of Unmodified EVOH Weft Knitted Fabric and Ny-6 Warp Knitted Fabric)

Then, a weft knitted fabric (basis weight: 60 g/m², single yarn fineness: 6.5 dtex, thickness: 0,664 mm, air permeability: 1700 cm³/cm²·s) having a basis weight approximately equal to that of the weft knitted fabric of Example 3 was produced, which was used as a fusing fabric (fusion material). Then, in the same manner as in Example 1, an unmodified EVOH weft knitted fabric and a Ny-6 warp knitted fabric were stacked, which was dry-heated and pressurized at 150° C. for 30 seconds to produce a laminate, and its air permeability, air permeability retention rate, peel strength, breathability, fusion property, and texture were evaluated. Table 1 shows the results.

### Comparative Example 4

The production of the unmodified EVOH fibers, the production of the laminate of unmodified EVOH weft knitted fabric/Ny-6 warp knitted fabric, and the evaluation of the air permeability, the air permeability retention ratio, the peel strength, the breathability, the fusion property, and the texture were performed in the same manner as in Comparative Example 3 except that the temperature for dry heating and pressurizing was changed to 170° C. Table 1 shows the results.

### Comparative Example 5

A weft knitted fabric (basis weight: 50 g/m², single yarn fineness: 6.5 dtex, thickness: 0.288 mm, air permeability: 2507 cm³/cm²·s) was produced using the Ny-6 fibers (unmodified Ny) used in Example 1, which was used as a fusing fabric (fusion material). In the same manner as in Example 1, the Ny-6 weft knitted fabric and the Ny-6 warp knitted fabric were stacked, which was dry-heated and pressurized at 150° C. for 30 seconds to produce a laminate, and its air permeability, air permeability retention rate, peel strength, breathability, fusion property, and texture were evaluated. Table 1 shows the results.

### Comparative Example 6

The production of the unmodified Ny fibers, the production of the laminate of unmodified Ny weft knitted fabric/Ny-6 warp knitted fabric, and the evaluation of the air permeability, the air permeability retention ratio, the peel strength, the breathability, the fusion property, and the texture were performed in the same manner as in Comparative Example 5 except that the temperature for dry heating and pressurizing was changed to 230° C. Table 1 shows the results.

### Comparative Example 7

The 6 mol % modified EVOH used in Example 1 was molten at 230° C. using an extruder, and produced into a film having a basis weight of 88 g/m² and a thickness of 0.08 mm, which was used as a fusion material. Subsequently, the 6 mol % modified EVOH film and the Ny-6 warp knitted fabric were stacked in the same manner as in Example 1, which was then heated and pressurized with a steam iron at 110° C. for 30 seconds to produce a laminate, and its air permeability, air permeability retention rate, peel strength, breathability, fusion property, and texture were evaluated. Table 1 shows the results.

### Comparative Example 8

TPU (E585, manufactured by Nippon Miractran Co, Ltd.) was molten at 230° C. using an extruder, then guided to a spin pack, and discharged from a nozzle with 12 holes each having a diameter of 0.5 mm at a spinneret temperature of 230° C. Thus, fibers were discharged from the spinning nozzle. Threads discharged from the spinneret were cooled using a 1.0 m-long cooling device which blows the air in a transverse direction. Thereafter, a silicone-based oil was applied as a spinning oil to the threads. Then, the threads were taken up via a roller at a take-over speed of 100 m/min to obtain TPU fibers of 78 dtex/12f of the present comparative example. In the same manner as in Example 1, a TPU weft knitted fabric and a Ny-6 warp knitted fabric were stacked, which was then heated and pressurized with a steam iron at 150° C. for 30 seconds to produce a laminate, and its air permeability, air permeability retention rate, peel strength, breathability, fusion property, and texture were evaluated. Table 1 shows the results.

TABLE 1

| | | | Softening | | | Basis |
|---|---|---|---|---|---|---|
| | | Melting | point of | | | weight of |
| | Fusion | point of | fusion | Treatment | Form of | fusing |
| | bonding | fusion | material | temp. | fusion | fabric |
| | Material | material | [° C.] | [° C.] | material | [g/m²] |
| Ex. 1 | 6 mol % modified EVOH | 104 | — | 110 | Warp knitted fabric | 19 |
| Ex. 2 | 6 mol % modified EVOH | 104 | — | 110 | Warp knitted fabric | 25 |
| Ex. 3 | 6 mol % modified EVOH | 104 | — | 110 | Warp knitted fabric | 41 |
| Ex. 4 | 6 mol % modified EVOH | 104 | — | 110 | Warp knitted fabric | 75 |
| Ex. 5 | Modified Ny | 99 | — | 110 | Warp knitted fabric | 17 |
| Ex. 6 | Modified Ny | 99 | — | 110 | Warp knitted fabric | 22 |
| Ex. 7 | Modified Ny | 99 | — | 110 | Warp knitted fabric | 40 |
| Ex. 8 | Modified Ny | 99 | — | 110 | Warp knitted fabric | 72 |
| Ex. 9 | 6 mol % modified EVOH | 104 | — | 110 | Nonwoven fabric | 52 |
| Ex. 10 | modified Ny | 99 | — | 110 | Nonwoven fabric | 46 |
| Ex. 11 | 4 mol % modified EVOH | 146 | — | 150 | Warp knitted fabric | 40 |
| Ex. 12 | TPU | — | 103 | 150 | Warp knitted fabric | 54 |
| Com. Ex. 1 | 6 mol % modified EVOH | 104 | — | 110 | Warp knitted fabric | 11 |
| Com. Ex. 2 | 6 mol % modified EVOH | 104 | — | 110 | Warp knitted fabric | 106 |
| Com. Ex. 3 | Unmodified EVOH | 160 | — | 150 | Warp knitted fabric | 60 |
| Com. Ex. 4 | Unmodified EVOH | 160 | — | 170 | Warp knitted fabric | 60 |
| Com. Ex. 5 | Unmodified Ny | 225 | — | 150 | Warp knitted fabric | 50 |
| Com. Ex. 6 | Unmodified Ny | 225 | — | 230 | Warp knitted fabric | 50 |
| Com. Ex. 7 | 6 mol % modified EVOH | 104 | — | 110 | Film | 88 |
| Com. Ex. 8 | TPU | — | 119 | 150 | Warp knitted fabric | 57 |

| | Air | Air | | Air | | | | |
|---|---|---|---|---|---|---|---|---|
| | permeability | permeability | | permeability | | | | |
| | of fusing | of laminate | | retention | | | | |
| | fabric | [cm³/cm² · s] | | rate of | | Peel | Fusion | |
| | [cm³/ | Before | After | laminate | | strength | bonding | |
| | cm² · s] | fusion | fusion | [%] | Breathability | [N/cm] | property | Texture |
| Ex. 1 | 8283 | 64 | 50 | 78 | Good | 17 | Average | Excellent |
| Ex. 2 | 5514 | 65 | 41 | 63 | Good | 20 | Good | Excellent |
| Ex. 3 | 2060 | 61 | 13 | 21 | Good | 22 | Good | Excellent |
| Ex. 4 | 1205 | 58 | 5 | 8.6 | Average | 25 | Good | Excellent |
| Ex. 5 | 9569 | 68 | 52 | 76 | Good | 16 | Average | Excellent |
| Ex. 6 | 6667 | 63 | 45 | 71 | Good | 20 | Good | Excellent |
| Ex. 7 | 2490 | 62 | 23 | 37 | Good | 22 | Good | Excellent |
| Ex. 8 | 1313 | 55 | 6 | 11 | Average | 27 | Good | Excellent |
| Ex. 9 | 2911 | 68 | 29 | 43 | Good | 21 | Good | Excellent |
| Ex. 10 | 3176 | 65 | 36 | 55 | Good | 22 | Good | Excellent |
| Ex. 11 | 3010 | 63 | 37 | 59 | Good | 18 | Average | Good |
| Ex. 12 | 2665 | 67 | 40 | 60 | Good | 13 | Average | Excellent |
| Com. Ex. 1 | 16492 | 63 | 60 | 95 | Good | 8 | Poor | Good |
| Com. Ex. 2 | 405 | 54 | 0.4 | 0.7 | Poor | 30 | Good | Good |
| Com. Ex. 3 | 1700 | 59 | 55 | 93 | Good | 4 | Poor | Excellent |
| Com. Ex. 4 | 1700 | 59 | 45 | 76 | Good | 18 | Average | Poor |
| Com. Ex. 5 | 2507 | 63 | 63 | 100 | Good | 0 | Poor | Excellent |
| Com. Ex. 6 | 2507 | 63 | 42 | 67 | Good | 25 | Good | Poor |
| Com. Ex. 7 | 0 | 0 | 0 | — | Poor | 32 | Good | Good |
| Com. Ex. 8 | 2456 | 64 | 54 | 84 | Good | 7 | Poor | Excellent |

As shown in Table 1, regarding the 6 mol % modified EVOH weft knitted fabrics of Examples 1 to 4 and the modified Ny weft knitted fabrics of Examples 5 to 8, in which the fusion material had a melting point of 150° C. or lower and an air permeability of 1000 cm³/cm²·s or more to 10000 cm³/cm²·s or less, the laminates each of which contains partially the fusing weft knitted fabric showed a peel strength of 10 N/cm or more, and an air permeability of 5 cm³/cm²·s or more. This indicates that the laminates had sufficient fusion property and breathability, and maintained the texture. Also, each of the 6 mol % modified EVOH nonwoven fabric of Example 9 and the modified Ny nonwoven fabric of Example 10 showed almost the same fusion property and breathability and maintained the texture when stacked with the Ny warp knitted fabric to produce the laminate. This indicates that the present invention is applicable to not only the weft knitted fabrics, but also the nonwoven fabrics. The 4 mol % modified EVOH weft knitted fabric of Example 11 had a higher melting point than the 6 mol % modified EVOH of Examples 1 to 4, and therefore, required a higher fusion temperature than the samples of Examples 1 to 10. However, the 4 mol % modified EVOH weft knitted fabric was revealed to have sufficient fusion property and breathability, while maintaining the texture. The TPU weft knitted fabric of Example 12 had a softening point of 110° C. or lower, and thus, had sufficient fusion property and breathability, and maintained the texture. It has been clarified that the above results are obtained only because the fusing fabric were sufficient in both of air permeability and fusion performance.

On the other hand, the modified EVOH weft knitted fabric of Comparative Example 1 made the fusion property of the resulting laminate poor because its air permeability was higher than 10000 cm³/cm²·s, and the modified EVOH weft knitted fabric of Comparative Example 2 made the air permeability of the laminate poor because its air permeability was less than 1000 cm³/cm²·s. In particular, it was clarified that the fabric of Comparative Example 2 had remarkably low air permeability retention rate as compared to the fabrics of Examples, which deteriorated the breathability to an uncomfortable level when stacked and fused with fabric. It was also found that the unmodified EVOH weft knitted fabric of Comparative Example 3 having a melting point of 160° C., and the Ny-6 (unmodified Ny) weft knitted fabric of Comparative Example 5 having a melting point as high as 225° C. were hardly fused through a dry heat treatment at 150° C., resulting in poor fusion property of the laminates. On the other hand, the unmodified EVOH and the unmodified Ny of Comparative Examples 4 and 6 were treated at higher temperature than those of Comparative Examples 3 and 5 in order to improve the fusion property of the laminate. As a result, the Ny knitted fabric to be fused was hardened and its texture was deteriorated. Further, the modified EVOH film of Comparative Example 7 had no breathability, and thus, made the laminate of the film and the Ny warp knitted fabric poorly breathable. It was also found that the TRU of Comparative Example 8 having a softening point higher than 110° C. was hardly fused through the dry heat treatment at 150° C., resulting in poor fusion property of the laminate.

1. A fusing fabric, comprising:
at least partially fusible fibers comprising a resin that has a melting point of 150° C. or lower or a softening point of 110° C. or lower, and having an air permeability of 1000 cm³/cm·²·s or more to 10000 cm³/cm²·s or less,
wherein the fusing fabric is suitable for thermal fusion of a plurality of plies of fabric.

2. The fusing fabric of claim 1, having a basis weight of 15 g/m² or more to 80 g/m² or less.

3. The fusing fabric of claim 1, wherein the fusible fibers are modified ethylene vinyl alcohol copolymer fibers or modified polyimide fibers.

4. A laminate comprising the fusing fabric of claim 1, and a plurality of plies of fabric to be thermally fused.

5. The laminate of claim 4, having a peel strength of 10 N/cm or more and an air permeability of 5 cm³/cm²·s or more.

6. A method for producing a laminate at least partially comprising the fusing fabric of claim 1 and a plurality of plies of fabric to be thermally fused, the method comprising heating the fusing fabric and the plurality of plies of fabric at a temperature of 150° C. or lower, thereby fusing the plurality of plies of fabric.

7. The laminate of claim 4, wherein plurality of plies of fabric comprises a woven fabric, a knitted fabric, a braid, a nonwoven fabric, a leather, or any combination thereof.

8. The method of claim 6, wherein plurality of plies of fabric comprises a woven fabric, a knitted fabric, a braid, a nonwoven fabric, a leather, or any combination thereof.

9. The fusing fabric of claim 1, wherein the fusing fabric does not comprise a film.

10. The laminate of claim 4, wherein the laminate does not comprise a film.

11. The method of claim 6, wherein the laminate does not comprise a film.

12. The method of claim 6, further comprising:
applying a dry heat treatment or a hydrothermal treatment to the fusing fabric and the plurality of plies of fabric, after heating the fusing fabric and the plurality of plies of fabric.

13. The method of claim 6, further comprising:
dyeing the fusing fabric and the plurality of plies of fabric, after heating the fusing fabric and the plurality of plies of fabric.

14. The fusing fabric of claim 1, wherein the fusible fibers are composite fibers comprising a plurality of resin components.

15. The fusing fabric of claim 14, wherein the plurality of resin components comprises a fusible resin having a fusion property and a resin or resins other than the fusible resin.

16. The fusing fabric of claim 1, wherein the fusible fibers comprise a resin which comprises inorganic particles.

17. The fusing fabric of claim 1, wherein the fusible fibers have a single yarn fineness of 0.2 dtex or more to 20 dtex or less.
